(19) United States
(12) Patent Application Publication
(10) Pub. No.: US 2025/0112797 A1
(43) Pub. Date: Apr. 3, 2025

(54) CONSENSUS PROTOCOL MODIFICATIONS

(71) Applicant: Ava Labs, Inc., New York, NY (US)

(72) Inventor: Stephen John Buttolph, Brooklyn, NY (US)

(21) Appl. No.: 18/901,820

(22) Filed: Sep. 30, 2024

Related U.S. Application Data
(60) Provisional application No. 63/541,702, filed on Sep. 29, 2023.

(51) Int. Cl. H04L 9/00

(52) U.S. Cl. CPC H04L 9/50

(57) ABSTRACT

Various aspects of the subject technology relate to systems, methods, and machine-readable media for implementing consensus protocols comprising separate preference selection and decision detection mechanisms to enhance the protocol. Various aspects may include executing a first mechanism configured to determine a preference, from one or more choices, for nodes in a blockchain network based on a first threshold value of the nodes agreeing on a selection of one of the choices. Aspects may also include executing a second mechanism configured to detect the blockchain network has decided on the selection based on a probabilistic analysis of node preferences and finalize a consensus decision of the blockchain network based on the node preferences.

### CROSS-REFERENCE TO RELATED APPLICATIONS

The present disclosure is related and claims priority, under 35 U.S.C. § 119(e), to U.S. Provisional Patent Application No. 63/541,702, entitled CONSENSUS PROTOCOL MODIFICATIONS, to Stephen John Buttolph, filed on Sep. 29, 2023, the contents of which are hereby incorporated by reference in their entirety, for all purposes.

### TECHNICAL FIELD

The present disclosure generally relates to consensus protocols in blockchain implementation, and more particularly to separating preference selection and detection mechanisms in the consensus protocols and implementing them using independently of each other (e.g., using distinct consensus protocol parameter(s) in each of the mechanisms).

### BACKGROUND

Conventional blockchain technology includes a growing list of records, called blocks, that are linked together. A blockchain network includes nodes such as a validator node that participates in consensus. In other words, validator nodes are capable of verifying, voting on, staking and/or maintaining a record of transactions for the blockchain network as well as storing a copy of the blockchain. Validators are also responsible for producing and/or proposing blocks for addition to the blockchain network. Blockchains may require a consensus protocol as a fundamental building block for building distributed systems. Validators can participate in the consensus protocol for implementation of blockchain deployments or building on subnets.

### SUMMARY

The subject disclosure provides for systems and methods for implementing consensus protocols by separating selecting and decision-making mechanisms. The two mechanisms may be tuned based on distinct parameters (hereafter referred to as “dual-alpha”). According to embodiments, a computer-implemented method for implementing the consensus protocol including two separate mechanisms for consensus is provided. The method includes executing a first mechanism configured to determine a preference, from one or more choices, for nodes in a blockchain network based on a first threshold value (i.e., a first alpha) of the nodes agreeing on a selection of one of the choices. The method also includes executing a second mechanism configured to detect the blockchain network has decided on the selection based on a probabilistic analysis of node preferences (i.e., a second alpha) and finalizing a consensus decision of the blockchain network based on the node preferences using the first and second mechanisms. The first and second mechanisms are separate and independent of each other.

According to embodiments, a system is provided including a processor and a memory comprising instructions stored thereon, which when executed by the processor, cause the processor to perform a method for implementing a consensus protocol including two separate mechanisms for consensus. The method includes determining, in a first mechanism of a consensus protocol, a preference, from one or more choices, for nodes in a blockchain network based on a first threshold value of the nodes agreeing on a selection of one of the choices. The method also includes detecting, in a second mechanism of the consensus protocol, the blockchain network has decided on the selection based on a probabilistic analysis of node preferences over at least a preset number of consecutive quorums. The method also includes finalizing a consensus decision of the consensus protocol for the blockchain network based on the node preferences.

According to embodiments, a non-transitory computer-readable storage medium is provided including instructions (e.g., stored sequences of instructions) that, when executed by a processor, cause the processor to perform a method for implementing a consensus protocol including two separate mechanisms for consensus. The method includes executing a first mechanism configured to determine a preference, from one or more choices, for nodes in a blockchain network based on a first threshold value of the nodes agreeing on a selection of one of the choices. The method also includes executing a second mechanism configured to detect the blockchain network has decided on the selection based on a probabilistic analysis of node preferences and finalize a consensus decision of the blockchain network based on the node preferences.

According to embodiments, a computer-implemented method for implementing a consensus protocol including two separate mechanisms for consensus is provided. The method may include a means for determining a preference, from one or more choices, for nodes in a blockchain network based on a first threshold value of the nodes agreeing on a selection of one of the choices. The method may also include a means for detecting the blockchain network has decided on the selection based on a second threshold value of the nodes agreeing on the preference. The method may also include finalizing a consensus decision of the blockchain network based on the preference, wherein the first threshold value and the second threshold value are distinct.

It is understood that other configurations of the subject technology will become apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an exemplary network architecture in which methods and systems may be implemented, according to certain aspects of the present disclosure.

FIG. 2 illustrates an exemplary block diagram of a consensus protocol including two separate mechanisms with dual-alpha modification capabilities, according to certain aspects of the present disclosure.

FIG. 3 is a block diagram illustrating a system configured for processing consensus protocols including two separate mechanisms for consensus, according to certain aspects of the present disclosure.

FIG. 4 illustrates an example process for implementing consensus protocols including two separate mechanisms for consensus, according to certain aspects of the present disclosure.

FIGS. 5A-5E illustrate simulations results with varied alpha parameter values, according to certain aspects of the present disclosure.

FIG. 6 is a block diagram illustrating an example computer system with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

### General Overview

Blockchain platforms, such as for smart contracts, may require a consensus protocol as a fundamental building block for building distributed systems. As an example, a blockchain platform can include multiple blockchains. A blockchain is a database that maintains records for transactions and tracking of assets in blocks and/or tokens. A blockchain platform may include nodes such as validator nodes that participate in consensus, helping the blockchain network reach agreement on the state of the blockchain. By non-limiting example, a subnet or subnetwork may include a dynamic set of validators seeking to achieve consensus on a state of a set of blockchains such that one blockchain is validated by one subnet although one subnet can validate multiple blockchains.

Validator nodes are capable of verifying, voting on, staking and/or maintaining a record of transactions for the blockchain network as well as storing a copy of the blockchain. Validators are also responsible for producing and/or proposing blocks for addition to, e.g., a same blockchain network. Validators can participate in protocols for implementation of blockchain deployments or building on subnets. Blockchains being validated by validators may be blockchain networks with application-level logic defined by multiple virtual machines (VMs) which enable more decentralized networks. In particular, a blockchain may be an instance of a VM that specifies the blockchain's state, state transition function, transactions, and application programming interface (API) for user interaction.

Consensus protocols may be used to coordinate blockchains on the blockchain platform. For example, the consensus protocol can be used for the metadata blockchain and/or the contract blockchain for building consensus for validators such as for custom subnets, execution of smart contracts, etc. The consensus protocol can be an all-to-all consensus protocol, a proof-of-work consensus protocol, or the like. As another example, a consensus protocol may operate via repeated subsampled voting such that validators provide strong probabilistic guarantees of accuracy without communicating with every other validator on a corresponding network.

As used herein, the term “blockchain” generally refers to an open and distributed public ledger comprising a growing list of records, which are linked using cryptography. By design, the blockchain is resistant to modification of the data. The blockchain can include an auditable database that provides a distributed, replicated ledger of cryptographically certified artifacts whose contents are extremely difficult to tamper with without detection, and therefore, are with very high probability, true copies of the intended content, and whose content are open for inspection via a suitable query interface.

As used herein, the term “block” generally refers to a record that is kept in a blockchain. For example, each block contains a cryptographic hash of the previous block, a timestamp, and transaction data, which can generally be represented as a Merkle tree root hash.

Consensus protocols may be used to coordinate between nodes in a distributed system to reach agreement on values or decisions. For example, the consensus protocol can be used for the metadata blockchain and/or the contract blockchain for building consensus for validators such as for custom subnets, execution of smart contracts, etc. The consensus protocol can be an all-to-all consensus protocol, a proof-of-work consensus protocol, or the like. There is generally a tradeoff between the liveness and safety of a consensus protocol. Liveness representing the guarantee that a protocol can exchange messages between nodes of the blockchain network, allowing the nodes to eventually come to a consensus. Safety represents the guarantee that a consensus or value between nodes is valid and consistent across the nodes of the blockchain network.

Consensus protocols that always maintain high safety and high liveness are not able to maintain efficient verification with a large number of members in the system, and thus are not favorable due to their lack of applicability. As a result of this, it may be advantageous and a technological improvement for blockchain networks to include a modification feature which can separate the selection and decision processes in the consensus protocols to the tradeoff risks.

Consensus protocols are configured with critical parameters including, for example, K representing the number of nodes to sample, alpha representing the number of required nodes to define a quorum, and beta representing the number of consecutive quorums to finalize a decision. Alpha-quorums are used to determine a local node's preferred choice. The consensus protocol may be broken up into a series of rounds. In each round, the consensus protocol may implement a subsampling approach where a group of K nodes in the network are asked to vote on a value to get an understanding of the network's opinions. The protocol waits to receive K responses from the sample group. If alpha of the value in the group of K samples is received, the value is adopted as the preference going forward, and a consecutive counter is incremented. Polling continues until the number of consecutive quorums to finalize a decision reaches alpha. The value is finalized for the network based on a series of beta consecutive polls reaching alpha of the same preference. That is, the same alpha threshold is used in the polling/selection as well as the finalization/decision process over a series of at least beta polls.

Embodiments of the present disclosure provide a consensus protocol comprising a first mechanism for the network to select a decision and a second mechanism for a node to detect that the network has selected a decision. Separating the two mechanisms optimize for both objectives (i.e., liveness and safety) without having a strict tradeoff between liveness and safety. According to embodiments, separating the two mechanisms enhances consensus protocols and allows for modifications to increase the safety parameter without significantly reducing the performance of the consensus protocol, even in the non-byzantine case.

According to some embodiments, to facilitate the separate, largely independent mechanisms, the consensus protocols may be configured with dual-alpha parameters. The first mechanism (or selection process) may be based on the value of alphaP and the second mechanism (or decision process) may be based on the value of alphaC for at least beta consecutive polls. AlphaP and alphaC may have different values designed to promote liveness and strengthen safety in the protocol. In embodiments, a preference may change based on alphaP and the network may finalize based on beta consecutive polls of alphaC. By separating the first and second mechanisms in the protocol, the definition of the alpha-quorum can be specialized to correctly optimize for both selecting a decision and detecting that a selection has been made. In conventional systems, the alpha value for the decision selection mechanism should be as low as possible to provide the fastest decision. However, because of the strict liveness-safety tradeoff, the alpha value for the decision detector should be tuned to be sufficiently large to provide network security.

Embodiments of the present disclosure address this issue by allowing both mechanisms to be tuned independently (e.g., using one or more alpha values), efficiently and securely implementing the consensus protocol. According to some embodiments, separation of the selection and decision mechanisms enhances processing flexibility of the protocol, enabling a wider range of possible operations to achieve consensus. According to some embodiments, the second mechanism may be implemented with more than a single threshold to allow it to detect finalization faster.

According to some embodiments, the second mechanism may be implemented without an alpha threshold and may use a probabilistic analysis based on the first mechanism. A probabilistic argument may be used to determine whether a sample sufficiently converges on the same decision for the network to commit the decision. By non-limiting example, the first mechanism may select a decision based on a first alpha and the second mechanism may calculate an error probability to decide. Based on the error probability being sufficiently low, the process can terminate regardless of the first alpha value. As such, the threshold in the second mechanism may be thought of as the probability that the first mechanism has succeeded.

The separation of the mechanisms, including the dual-alpha modification, may be applied to any consensus protocol including, but not limited to, a polling structure, all-to-all communication, or the like, with varied levels of separation between the selection and decision mechanisms to achieve consensus in a distributed system.

The disclosed system addresses a problem in blockchain technology tied to computer technology, namely, the technical problems in consensus protocol implementation in blockchains used to verify blocks across all nodes in the blockchain. The disclosed system solves this technical problem by providing a solution also rooted in computer technology, namely, by providing for systems and methods for separating the consensus protocol into independently operating mechanisms. The disclosed system also provides the advantage of increasing safety without being impacted by the strict tradeoff between safety and liveness. The disclosed system also improves security of blockchain networks and transactions made therein.

### Example Architecture

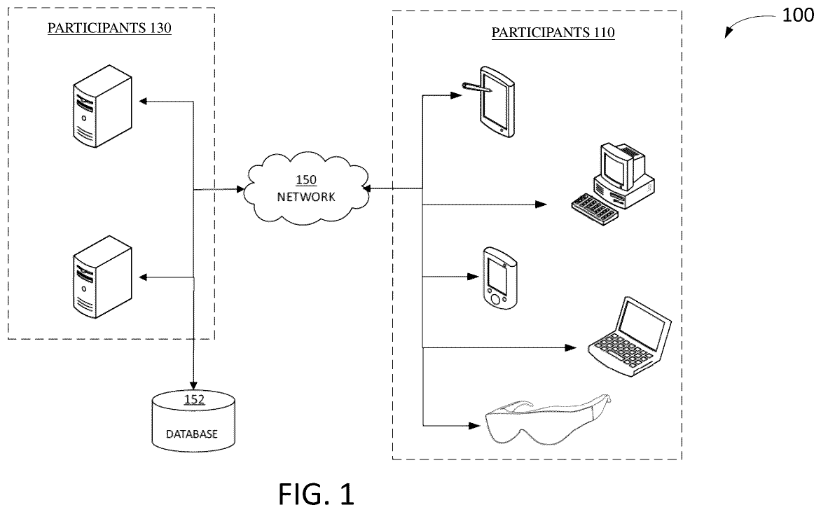

FIG. 1 illustrates an exemplary network architecture 100 of a blockchain platform (e.g., blockchain network implementation/deployment platform) for managing consensus protocols, according to some embodiments. The blockchain may be a linear chain of blocks of the same dimension, such as the same height, size, length, etc. Blocks of the blockchain may comprise or store data or organized information (e.g., records of information), including a cryptographic hash of the previous block, a timestamp, and transaction data, for example.

The network architecture 100 of FIG. 1 includes one or more participants 110 (e.g., client device) and one or more participants 130 (e.g., server) which are communicatively coupled via a network 150. The blockchain architecture of the network architecture 100 can be a distributed database that maintains a continuously growing list of ordered records as the blocks. The blockchain architecture may implement methods and systems according to one or more embodiments. The blockchain architecture may host applications bridging and otherwise handling assets and transactions over multiple blockchains and/or subnets, e.g., running in participants 110 and/or participants 130.

The network 150 may include a wired network (e.g., via fiber optic or copper wire, telephone lines, and the like) or wireless network (e.g., a cellular network, radio-frequency (RF) network, Wi-Fi, Bluetooth, and the like). The network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like.

Participants 110 and/or participants 130 may be clients of the blockchain platform for creating, expanding, or otherwise modifying customized blockchain networks and/or private or public subnets. It is understood that the participants 130 may include the participants 110 as well, such that they are peers. As an example, the participants 110 may be different computers linked by the network 150 in a blockchain network having a same database. As an example, the participants 110 can function as virtual machines (VMs) that form nodes of the network architecture 100. The participants 110 that function as nodes can run software to verify block and transaction data, store data, validate, respond to network requests for data, and/or the like for the existing blockchain. VMs can be computers that run on blockchain and allow smart contracts from multiple sources to interact with one another. The participants 110 can generate blocks upon request by the participants 130, such as via a consensus engine or module of the participants 130 at a particular time such as during a specified temporal submission window. The blocks being generated and proposed for addition to the existing blockchain may be validated as being a valid block before its addition.

The network architecture 100 can incorporate application of a consensus protocol that is high throughput, totally-ordered, and effective for smart contracts. Smart contracts may refer to self-executing computer programs, applications, or contracts for executing transactions such as financial transactions involving cryptocurrency. The network architecture 100 may be used for creation of custom blockchains (including private blockchains) and decentralized applications (dApps). The consensus protocol may be for agreement on the validity of user transactions, adding blocks to the existing blockchain, interaction with external resources (e.g., off-chain), etc. The consensus protocol implemented by the network architecture 100 may be a de-centralized, leaderless block proposal mechanism that handles multiple valid block proposals concurrently and limits the submission of proposals for the existing blockchain. As an example, the network architecture 100 may use repeated subsample voting and validators may provide strong probabilistic guarantees of correctness (e.g., safety and liveness).

According to embodiments, the network architecture 100 may implement dual-alpha consensus protocols in the blockchains based on a set of parameters, maintaining the safety and liveness of the protocol. The dual-alpha consensus protocol is designed to facilitate a seamless operation of the selection and decision-making processes in the protocol. Each process may be handled by independent alpha values, essentially separating the consensus protocols into two mostly independent mechanisms.

The participants 130 may be virtual machines (VMs) running on a different blockchain platform from participants 110. The participants 130 may store data of the existing blockchain in a peer-to-peer (P2P) and/or distributed ledger fashion in a database 152. The database 152 may store relevant information regarding, for example, execution, and verification logic and/or rules for implementing consensus protocols, etc. Database 152 may store backup files from blockchain transactions, smart contracts, signatures, and digital assets including tokens, cryptocurrencies, smart contracts, encryption keys, signature keys, and financial data. In particular, the participants 130 may function in conjunction to autonomously manage the decentralized database(s) of the existing blockchain via the P2P network and a distributed timestamping server of the participants 130. The participants 130 may be configured to implement multiple chains of the network architecture 100. For example, the participants 130 can implement a plurality of chains of the network architecture 100, such as an asset blockchain (e.g., for creating new assets, asset exchange, cross-subnet transfers), metadata blockchain (e.g., for coordinating validators, tracking active subnets, and creating new subnets), smart contract blockchain (e.g., for creating smart contracts and applications that require total ordering), etc.

Each of the participants 130 may be a computing device such as part of a cloud computing server or group of cloud computing servers including one or more desktop computers or panels mounted on racks, and/or the like. The panels may include processing boards and also switchboards, routers, and other network devices. The network architecture 100 will allow participants 110/130 to seamlessly transfer assets between chains. In some implementations, the participants 130 may not be cloud-based (i.e., may be implemented outside of a cloud computing environment) or may be partially cloud-based.

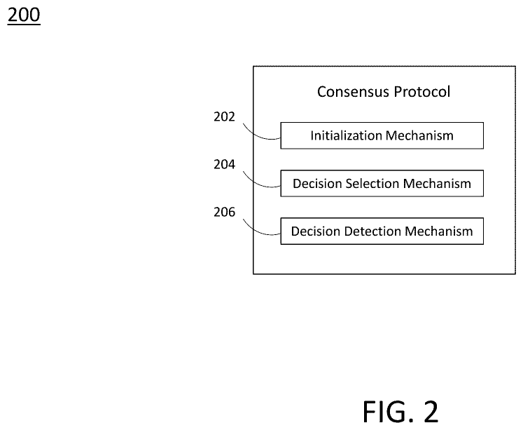

FIG. 2 illustrates an exemplary block diagram of a consensus protocol 200 with dual-alpha modification capabilities in a blockchain network, according to certain aspects of the present disclosure. Running the consensus protocol with dual-alpha values better separates the mechanism for the network to select a decision and the mechanism for a node to detect that the network has selected a decision. This allows for increasing a safety parameter without significantly reducing the performance of the consensus protocol.

As shown in FIG. 2, the consensus protocol 200 may include a decision selection mechanism 204 and decision detection mechanism 206. The mechanisms are separate and may process independent of each other. In embodiments, steps/operations of the mechanisms may be performed concurrently. Each mechanism may implement a different polling parameter which ultimately encourages safe progression of the consensus protocol.

Before performing operations of the mechanisms, consensus protocol 200 must ensure that each node will ultimately have some preference. Initialization mechanism 202 may initialize choices by gossiping the potential choices through the blockchain network. Initialization mechanism 202 may be performed according to a gossip protocol defining a type of peer-to-peer communication protocol that allows for distribution of information to all nodes on the blockchain network by, for example, disseminating the information from one node to another. Gossiping the choices ensures that the possible sequence of events (e.g., markovian process) in the blockchain are initialized correctly. The probability of each event depends on the state attained in the previous event.

The decision selection mechanism 204 is configured to select a decision for the blockchain network. Nodes may be randomly repeatedly sampled throughout the blockchain network to cause the network to prefer one of the choices. For example, each node may sample the network to update their own preference to a majority preference of the network, overtime causing the network to prefer a choice. In some implementations, the nodes are queried and, in response to the queries, each node reports their preference. If a node observes that a majority of the network is preferring a given choice, the node may decide on the same choice as it is probabilistically unlikely that the network will decide on another choice. Without the network selecting a single choice, consensus will never be reached, and the network would halt. The decision selection mechanism 204 is responsible for ensuring progress towards selecting a preference and eventual decision-making, maintaining liveness in the consensus protocol 200. According to embodiments, executing the decision selection mechanism 204 determines a preference, from possible choices, for nodes in the blockchain network.

The decision detection mechanism 206 is configured to detect that the network has finalized a decision, indicating that the nodes have agreed on a preference for the network. The decision detection mechanism 206 randomly samples nodes throughout the blockchain network to identify if the network has decided, identifying and maintaining a current state of the network. According to embodiments, executing the decision detection mechanism 206 detects the blockchain network has decided. According to some embodiments, the consensus protocol 200 may perform a safety analysis to ensure that when a decision is made that it is a safe decision. The safety analysis also provides a strong probabilistic argument for a given decision.

Once the decision detection mechanism 206 identifies that the nodes have decided (i.e., agreed on a preference), the decision of the network is finalized. Knowing that the network has finalized a decision is critical both for users to know their transaction has settled and for the system itself to be able to manage its internal databases efficiently.

According to embodiments, the decision selection mechanism 204 and the decision detection mechanism 206 are not limited to the sampling-based mechanisms as described with reference to FIG. 2. By non-limiting example, one or more of the decision selection mechanism 204 and the decision detection mechanism 206 may implement a subsampling mechanism or an all-to-all detection mechanism. In some implementations, in each poll, the decision selection mechanism 204 and decision detection mechanism 206 may implement different mechanisms (e.g., the decision selection mechanism 204 may perform subsampling and the decision detection mechanism 206 may perform a probabilistic analysis to finalize a choice).

According to embodiments, separating operations of the decision selection mechanism 204 and the decision detection mechanism 206 enhances processing flexibility of the protocol and the implementation of different alpha values in each mechanism without compromising on safety. The separation enhances the consensus protocol's efficiency, speed, and integrity. The decision selection mechanism 204 and the decision detection mechanism 206 processing based on independent alpha values reduces the risk of endless polling cycles that could otherwise hinder progress and compromise the system's liveness. This streamlines the process of reaching agreement and finalizing decisions among nodes, effectively preventing the protocol from becoming stuck in its initial state. Additionally, it preserves the safety of decisions once they are made, guaranteeing that finalized outcomes remain secure and immutable.

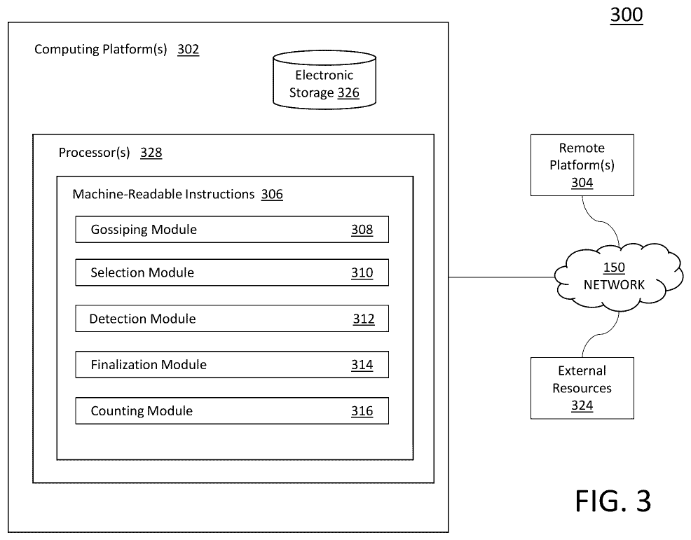

FIG. 3 illustrates a system 300 configured for processing consensus protocols using a dual-alpha modification, in accordance with one or more implementations.

In some implementations, system 300 includes one or more computing platforms 302. Computing platform(s) 302 can be configured to communicate with one or more remote platforms 304 according to a client/server architecture, a peer-to-peer architecture, and/or other architectures. Remote platform(s) 304 can be configured to communicate with other remote platforms via computing platform(s) 302 and/or according to a client/server architecture, a peer-to-peer architecture, and/or other architectures. Users can access system 300 via remote platform(s) 304. The computing platform(s) 302, external resources 324, and remote platform(s) 304 may be in communication and/or mutually accessible via the network 150.

Computing platform(s) 302 can be configured by machine-readable instructions 306. Machine-readable instructions 306 includes one or more instruction modules. The instruction modules include computer program modules. The instruction modules include one or more of gossiping module 308, selection module 310, detection module 312, finalization module 314, counting module 316, and/or other instruction modules. According to embodiments, the instructions modules may execute concurrently.

The gossiping module 308 may be configured to gossip choices throughout the network, ensuring that the protocol is initialized and that all nodes will eventually decide on a preference.

The selection module 310 may be configured to select a preference for nodes in the network. The selection may be based on a subsampling approach where nodes are randomly sampled throughout the network. All the nodes are performing the mechanism of the selection module 310 concurrently. Each node switches its preference based on its perception of the collective preference of the other nodes in the network. By doing this, the network implicitly decides on that value. In some embodiments, the mechanism of the selection module 310 may be based on a first predetermined alpha value (hereafter referred to as “alphaP”). For example, for a node to select a preference, at least alphaP of the subsample must prefer that preference. By non-limiting example, alphaP may equal 51%, making the network more willing to change a preference and ensuring liveness of the protocol. Only 51% of the sample must favor a preference for nodes to switch their preference.

The detection module 312 may be configured to detect when the nodes have agreed on a decision based on a probabilistic analysis of the network. The detection module 312 detects that the network has implicitly decided on a value when the nodes reach an irreversible decision state (i.e., the point when a node actually decides on a value and will never change its preference). This state is characterized by nodes committing to a particular value and ceasing to modify their preference. The mechanism of the detection module 312 may identify this collective behavior as an implicit consensus according to the probabilistic analysis, signaling the completion of the decision-making process across the network.

In some embodiments, the probabilistic analysis of the detection module 312 may be based on a second predetermined alpha value (hereafter referred to as “alphaC”). The detection may be based on a subsampling approach where nodes are randomly sampled throughout the network to identify whether the network has decided based on beta consecutive polls reaching alphaC. By non-limiting example, alphaC may equal 75%. Therefore, the detection module 312 may detect that the network has decided on a preference based on at least 75% of beta polls successfully reaching that preference, ensuring the safety of the consensus protocol.

The finalization module 314 may be configured to finalize a preference based on the network deciding on a preference at alphaC and terminate the poll in the consensus protocol. The decision is finalized in response to the detecting at the detection module 312. According to some embodiments, the finalized preference may represent a current state of the network and may be stored, for example, in database 152, to disk, persistent storage, or the like, minimizing network latencies and optimizing storage usage.

According to embodiments, the selection module 310 and the detection module 312 are not limited to the sampling approach to reach consensus using the dual-alpha values. Any mechanism which can provide a sufficiently strong probabilistic argument that the network has selected a value can be used to implement the detection module 312 including, but not limited to, alphaC and consecutive beta, multiple alpha and beta conditions, alphaC and non-consecutive beta percentage, etc. By non-limiting example, one or both mechanisms may select a most frequent preference over a predetermined amount of time, number of polls, or the like. In some implementations, rather than requiring beta consecutive polls, detection module 312 may implement a rule for detecting a decision. By non-limiting example, the detection module 312 may require at least a percentage of the last x polls reaching alphaC in order to finalize a decision, x representing a predetermined number.

The counting module 316 may serve as a counter or be configured to increment a consecutive counter tracking the polls, wherein preferences are finalized in each poll. According to embodiments, the counting module 316 may be a part of the protocol of the detection module 312. For example, in an alphaC and consecutive beta implementation for the detection module 312, the counting module 316 may count the number of consecutive polls that have reached the alphaC threshold and mark the preference as finalized if the count reaches beta.

A given remote platform 304 includes one or more processors configured to execute computer program modules. The computer program modules can be configured to enable an expert or user associated with the given remote platform 304 to interface with system 300 and/or external resources 324, and/or provide other functionality attributed herein to remote platform(s) 304. By way of non-limiting example, a given remote platform 304 and/or a given computing platform 302 includes one or more of a server, a desktop computer, a laptop computer, a handheld computer, a tablet computing platform, a NetBook, a Smartphone, a gaming console, and/or other computing platforms.

External resources 324 includes sources of information outside of system 300, external entities participating with system 300, and/or other resources. In some implementations, some or all of the functionality attributed herein to external resources 324 can be provided by resources included in system 300.

Computing platform(s) 302 include(s) electronic storage 326, one or more processors 328, and/or other components. Computing platform(s) 302 include(s) communication lines, or ports to enable the exchange of information with a network and/or other computing platforms. Illustration of computing platform(s) 302 is not intended to be limiting. Computing platform(s) 302 include(s) a plurality of hardware, software, and/or firmware components operating together to provide the functionality attributed herein to computing platform(s) 302. For example, computing platform(s) 302 can be implemented by a cloud of computing platforms operating together as computing platform(s) 302.

Electronic storage 326 can include non-transitory storage media that electronically stores information. The electronic storage media of electronic storage 326 includes one or both of system storage that is provided integrally (e.g., substantially non-removable) with computing platform(s) 302 and/or removable storage that is removably connectable to computing platform(s) 302 via, for example, a port (e.g., a USB port, a firewire port, etc.) or a drive (e.g., a disk drive, etc.). Electronic storage 326 includes one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 326 includes one or more virtual storage resources (e.g., cloud storage, a virtual private network, and/or other virtual storage resources). Electronic storage 326 can store software algorithms, information determined by processor(s) 328, information received from computing platform(s) 302, information received from remote platform(s) 304, and/or other information that enables computing platform(s) 302 to function as described herein.

Processor(s) 328 can be configured to provide information processing capabilities in computing platform(s) 302. As such, processor(s) 328 includes one or more of a digital processor, an analog processor, a digital circuit designed to process information, an analog circuit designed to process information, a state machine, and/or other mechanisms for electronically processing information. Although processor(s) 328 is shown as a single entity, this is for illustrative purposes only. In some implementations, processor(s) 328 includes a plurality of processing units. These processing units can be physically located within the same device, or processor(s) 328 can represent processing functionality of a plurality of devices operating in coordination. Processor(s) 328 can be configured to execute modules 308, 310, 312, 314, and/or 316, and/or other modules. Processor(s) 328 can be configured to execute modules 308, 310, 312, 314, and/or 316, and/or other modules by software, hardware, firmware, some combination of software, hardware, and/or firmware, and/or other mechanisms for configuring processing capabilities on processor(s) 328. As used herein, the term “module” can refer to any component or set of components that perform the functionality attributed to the module. This includes one or more physical processors during execution of processor readable instructions, the processor readable instructions, circuitry, hardware, storage media, or any other components.

It should be appreciated that although modules 308, 310, 312, 314, and/or 316 are illustrated as being implemented within a single processing unit, in implementations in which processor(s) 328 includes multiple processing units, one or more of modules 308, 310, 312, 314, and/or 316 can be implemented remotely from the other modules. The description of the functionality provided by the different modules 308, 310, 312, 314, and/or 316 described below is for illustrative purposes, and is not intended to be limiting, as any of modules 308, 310, 312, 314, and/or 316 can provide more or less functionality than is described. For example, one or more of modules 308, 310, 312, 314, and/or 316 can be eliminated, and some or all of its functionality can be provided by other ones of modules 308, 310, 312, 314, and/or 316. As another example, processor(s) 328 can be configured to execute one or more additional modules that can perform some or all of the functionality attributed below to one of modules 308, 310, 312, 314, and/or 316.

The techniques described herein can be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

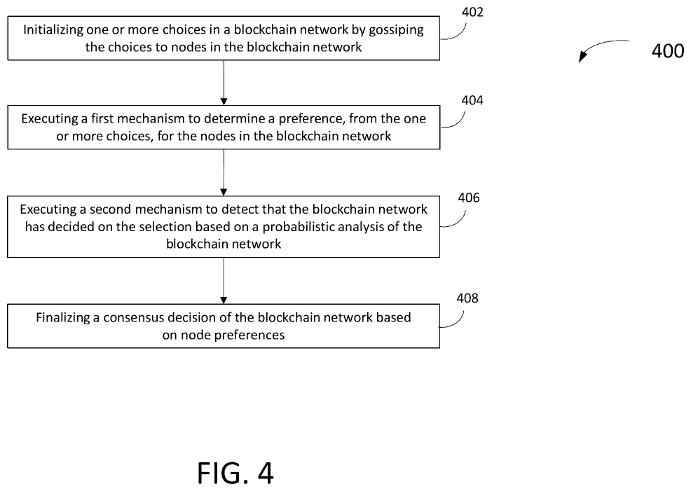

FIG. 4 illustrates an example workflow of a process 400 for implementing consensus protocols, according to certain aspects of the disclosure. For explanatory purposes, the steps of the example process 400 are described herein as occurring in serial, or linearly. However, multiple instances of the example process 400 may occur in parallel, overlapping in time, almost simultaneously, or in a different order from the order illustrated in the process 400. In addition, the blocks of the example process 400 need not be performed in the order shown and/or one or more of the blocks of the example process 400 need not be performed.

At step 402, the process 400 includes initializing one or more choices in a blockchain network by gossiping the choices to nodes in the blockchain network.

At step 404, the process 400 includes executing a first mechanism to determine a preference, from the one or more choices, for the nodes in the blockchain network. The preference may be selected based on a first threshold value of the nodes agreeing on a selection of one of the choices. According to embodiments, the first threshold value may correspond to a number or percentage of nodes required to define a quorum in the consensus protocol. In some embodiments, each of the nodes randomly sample the blockchain network to determine the preference. By non-limiting example, nodes may sample a subset of the nodes and receive responses from the subset of nodes indicating their choice selections. Each of the nodes may select the preference based on the responses reaching the first threshold value (e.g., 51%).

According to embodiments, nodes may modify or switch their selection of a choice (i.e., their preference) based on preferences of other nodes in the blockchain network reaching at least the first threshold value. Consequently, as more nodes opt for a particular choice, the network rapidly converges towards consensus, ultimately favoring that particular choice. In some implementations, a node automatically updates its preference based on a majority choice selection in the blockchain network.

At step 406, the process 400 includes executing a second mechanism to detect that the blockchain network has decided on the selection based on a probabilistic analysis of the blockchain network. According to some embodiments, the probabilistic analysis may include detecting that the blockchain network has decided on the selection based on a second threshold value of the nodes agreeing on the preference from the first mechanism. The second threshold may correspond to at least one of a single threshold (e.g., alphaC), multiple thresholds, or a statistical analysis of recent responses (i.e., without an explicit alpha threshold), etc.

According to embodiments, the first threshold value may correspond to a number or percentage of nodes required to define a quorum in the consensus protocol. In some embodiments, the second mechanism may comprise randomly sampling a subset of nodes and detecting that the blockchain network has decided based on at least the subset of nodes indicating a selected preference reaching the second threshold value (e.g., 75%). The detection may further depend on a predetermined length of polling. By non-limiting example, at least a preset number of consecutive quorums may be required to finalize the preference at the second threshold value.

According to embodiments, the first and second mechanisms are separate and may process independently of each other. Operations of the mechanisms may be performed concurrently and in accordance with distinct threshold values to help the protocol maintain a level of liveness without sacrificing safety.

At step 408, the process 400 includes finalizing a consensus decision of the blockchain network based on the preference. A current state of the consensus decision may be tracked/recorded on the blockchain network. The current state may be updated based on preferences of the nodes, for example, shifting or changing over polls of the consensus protocol.

In some implementations, one or more operation blocks of FIG. 4 may be performed by a processor circuit executing instructions stored in a memory circuit, in a client device, a remote server or a database, communicatively coupled through a network (e.g., processors 328, participants 110/130, database(s) 152, and network 150).

Although FIG. 4 shows example blocks of the process 400, in some implementations, the process 400 may include additional blocks, fewer blocks, different blocks, or differently arranged blocks than those depicted in FIG. 4.

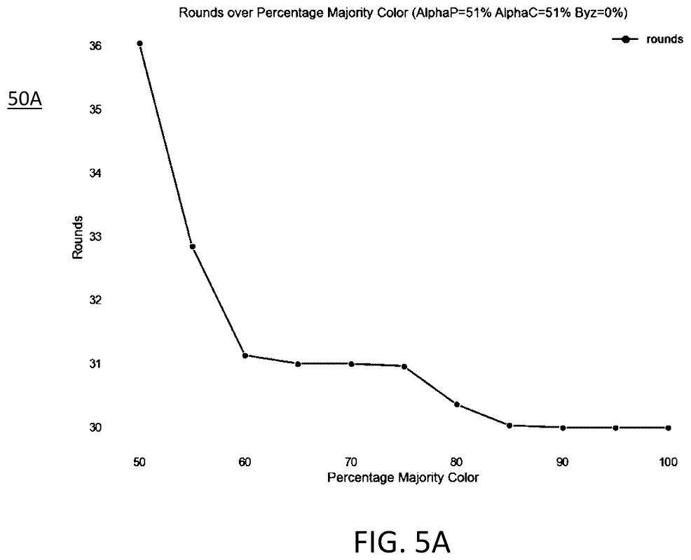

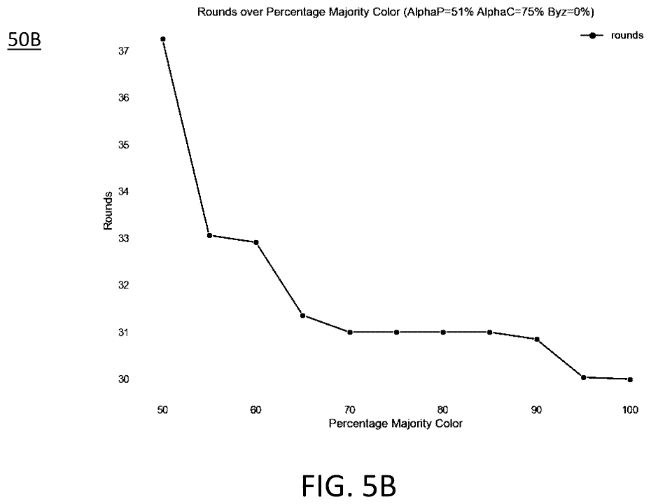

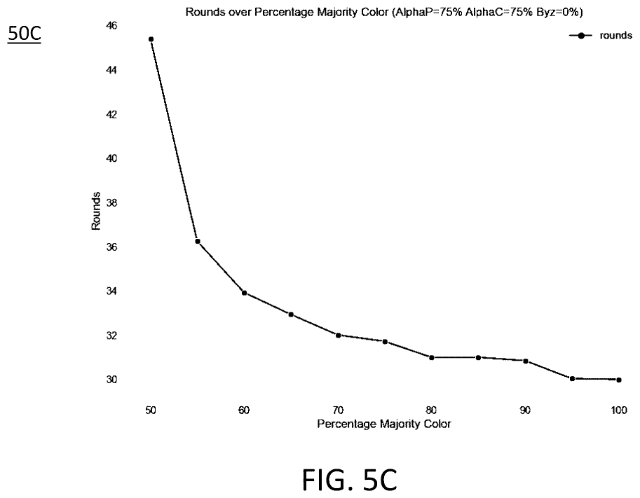

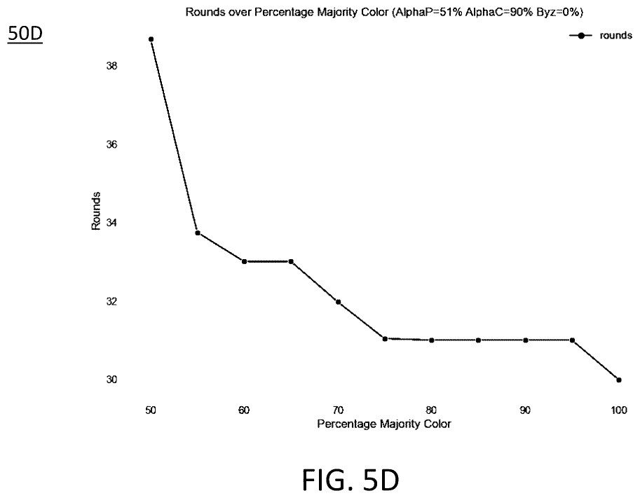

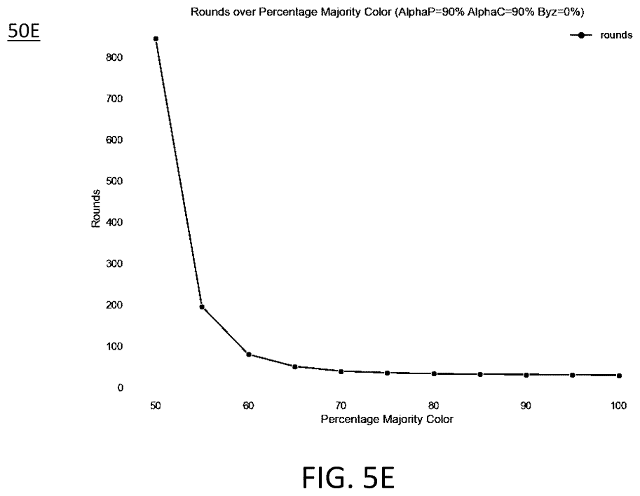

FIGS. 5A-5E illustrates graphs 50A-50E, respectively, representing simulations results with varied alpha parameter values in a dual-alpha consensus protocol, according to certain aspects of the present disclosure. According to embodiments, the selection and decision mechanisms of the protocol are separated, and the alpha thresholds are set independently in each of the mechanisms. Decreasing alphaP in the selection mechanism reduces the number of rounds required to terminate, while increasing alphaC in the detection mechanism increases the security of the protocol. Without separating these values, the system needs to decide whether to optimize for fewer rounds or for higher security. The dual-alpha modification of embodiments remedies this issue.

As shown in FIGS. 50A-50E, the graphs 50A-50E are generated based on a number of rounds over percentage majority color (i.e., a color preference or color choice). Each round may represent an attempt to reach consensus (e.g., one or more iterations of polling).

In FIG. 5A, graph 50A illustrates results of a simulation in the non-byzantine case (i.e., Byz=0%) based on the following parameters: alphaP equal to 51% and alphaC equal to 51%. In FIG. 5B, graph 50B illustrates results of the simulation in the non-byzantine case based on the following parameters: alphaP equal to 51% and alphaC equal to 75%. In FIG. 5C, graph 50C illustrates results of the simulation in the non-byzantine case based on the following parameters: alphaP equal to 75% and alphaC equal to 75%. In FIG. 5D, graph 50D illustrates results of the simulation in the non-byzantine case based on the following parameters: alphaP equal to 51% and alphaC equal to 90%. In FIG. 5E, graph 50E illustrates results of the simulation in the non-byzantine case based on the following parameters: alphaP equal to 90% and alphaC equal to 90%.

According to embodiments, fewer rounds (i.e., smaller Y-axis values) are overall better for consensus protocols and may result in lower latency, higher throughput, and increased efficiency in reaching consensus. The dual-alpha implementation in the consensus protocols enables separation of the mechanisms and allows for flexibility in their parameter values. As shown in graphs 50A-50E, decreasing the alphaP value corresponding to a decision selection mechanism of the protocol significantly reduces the number of rounds required for termination when the percentage of majority color is close to 50% and the alphaC value corresponding to a decision detection mechanism of the protocol is large.

### Hardware Overview

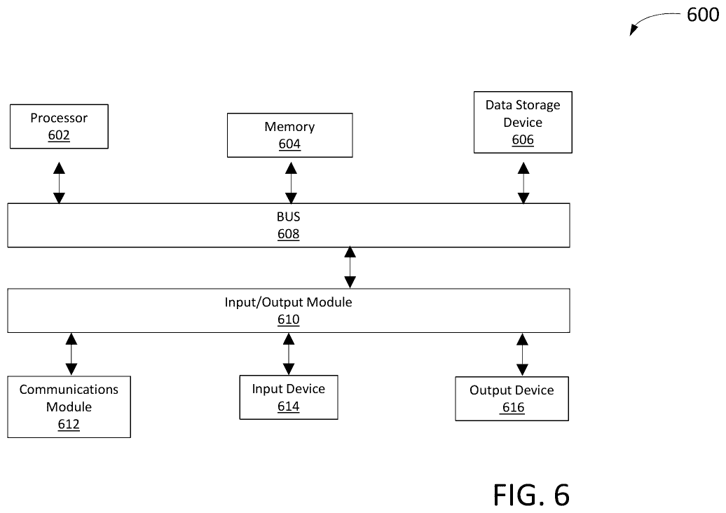

FIG. 6 is a block diagram illustrating an exemplary computer system 600 with which aspects of the subject technology can be implemented. In certain aspects, the computer system 600 may be implemented using hardware or a combination of software and hardware, either in a dedicated server, integrated into another entity, or distributed across multiple entities.

The computer system 600 (e.g., server and/or participant) includes a bus 608 or other communication mechanism for communicating information, and a processor 602 coupled with the bus 608 for processing information. By way of example, the computer system 600 may be implemented with one or more processors 602. Each of the one or more processors 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

The computer system 600 can include, in addition to hardware, code that creates an execution environment for the computer program in question, e.g., code that constitutes processor firmware, a protocol stack, a database management system, an operating system, or a combination of one or more of them stored in an included memory 604, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. Processor 602 and memory 604 can be supplemented by, or incorporated in, special purpose logic circuitry.

The instructions may be stored in memory 604 and implemented in one or more computer program products, i.e., one or more modules of computer program instructions encoded on a computer-readable medium for execution by, or to control the operation of, the computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by the processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

The computer system 600 further includes a data storage device 606 such as a magnetic disk or optical disk, coupled to bus 608 for storing information and instructions. The computer system 600 may be coupled via input/output module 610 to various devices. The input/output module 610 can be any input/output module. Exemplary input/output modules 610 include data ports such as USB ports. The input/output module 610 is configured to connect to a communications module 612. Exemplary communications modules 612 include networking interface cards, such as Ethernet cards and modems. In certain aspects, the input/output module 610 is configured to connect to a plurality of devices, such as an input device 614 and/or an output device 616. Exemplary input devices 614 include a keyboard and a pointing device, e.g., a mouse or a trackball, by which a user can provide input to the computer system 600. Other kinds of input devices can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 616 include display devices such as an LCD (liquid crystal display) monitor, for displaying information to the user.

According to one aspect of the present disclosure, the above-described systems can be implemented using a computer system 600 in response to the processor 602 executing one or more sequences of one or more instructions contained in the memory 604. Such instructions may be read into memory 604 from another machine-readable medium, such as data storage device 606. Execution of the sequences of instructions contained in the main memory 604 causes the processor 602 to perform the process steps described herein. One or more processors in a multi-processing arrangement may also be employed to execute the sequences of instructions contained in the memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

The computer system 600 can include clients and servers. A client and server are generally remote from each other and typically interact through a communication network. The relationship of client and server arises by virtue of computer programs running on the respective computers and having a client-server relationship to each other. The computer system 600 can be, for example, and without limitation, a desktop computer, laptop computer, or tablet computer. The computer system 600 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to the processor 602 for execution. Such a medium may take many forms, including, but not limited to, non-volatile media, volatile media, and transmission media. Non-volatile media include, for example, optical or magnetic disks, such as the data storage device 606. Volatile media include dynamic memory, such as the memory 604. Transmission media include coaxial cables, copper wire, and fiber optics, including the wires that comprise the bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A computer-implemented method for implementing consensus protocols, the method comprising:
executing a first mechanism configured to determine a preference, from one or more choices, for nodes in a blockchain network based on a first threshold value of the nodes agreeing on a selection of one of the choices; and
executing a second mechanism configured to:
detect the blockchain network has decided on the selection based on a probabilistic analysis of node preferences; and
finalize a consensus decision of the blockchain network based on the node preferences.

2. The computer-implemented method of claim 1, further comprising initializing the one or more choices by gossiping the one or more choices to the nodes in the blockchain network.

3. The computer-implemented method of claim 1, wherein the probabilistic analysis is based on a second threshold value of the nodes agreeing on the preference, the first threshold value and the second threshold value corresponding to a number of the nodes required to define a quorum in a consensus protocol, and wherein the first threshold value and the second threshold value are distinct.

4. The computer-implemented method of claim 1, wherein the first threshold value of the first mechanism is equal to 51% and a second threshold value of the second mechanism is equal to 75%.

5. The computer-implemented method of claim 1, wherein detecting the blockchain network has decided on the selection includes a second threshold value of the nodes agreeing on the preference for at least a preset number of consecutive quorums.

6. The computer-implemented method of claim 1, further comprising switching, based on preferences of the nodes in the blockchain network reaching at least the first threshold value, the selection corresponding to at least one of the nodes of the blockchain network.

7. The computer-implemented method of claim 1, further comprising tracking a current state of the consensus decision of the blockchain network, and updating the current state based on preferences of the nodes.

8. The computer-implemented method of claim 1, further comprising updating a node preference based on a majority choice selection in the blockchain network.

9. The computer-implemented method of claim 1, wherein executing the first mechanism configured to determine the preference further comprises:
randomly sampling a subset of the nodes;
receiving responses from the subset indicating choice selections; and
selecting the preference based on the responses reaching the first threshold value.

10. The computer-implemented method of claim 1, wherein executing the second mechanism configured to detect that the blockchain network has decided further comprises:
randomly sampling a subset of the nodes; and
detecting that the blockchain network has decided based on at least the subset indicating a selected preference reaching a second threshold value.

11. A system for implementing consensus protocols, comprising:
one or more processors; and
a memory comprising instructions stored thereon, which when executed by the one or more processors, causes the one or more processors to:
determine, in a first mechanism of a consensus protocol, a preference, from one or more choices, for nodes in a blockchain network based on a first threshold value of the nodes agreeing on a selection of one of the choices;
detect, in a second mechanism of the consensus protocol, the blockchain network has decided on the selection based on a probabilistic analysis of node preferences over at least a preset number of consecutive quorums; and
finalize a consensus decision of the consensus protocol for the blockchain network based on the node preferences.

12. The system of claim 11, wherein the instructions, when executed by the one or more processors, cause the one or more processors to initialize the one or more choices by gossiping the one or more choices to the nodes in the blockchain network.

13. The system of claim 11, wherein the probabilistic analysis is based on a second threshold value of the nodes agreeing on the preference for the preset number of consecutive quorums, the first threshold value and the second threshold value corresponding to a number of the nodes required to define a quorum in the consensus protocol.

14. The system of claim 13, wherein the first threshold value is equal to 51% and the second threshold value is equal to 75%.

15. The system of claim 11, wherein the instructions, when executed by the one or more processors, cause the one or more processors to switch, based on preferences of the nodes in the blockchain network reaching at least the first threshold value, the selection corresponding to at least one of the nodes of the blockchain network.

16. The system of claim 11, wherein the instructions, when executed by the one or more processors, cause the one or more processors to track a current state of the consensus decision of the blockchain network, and update the current state based on preferences of the nodes.

17. The system of claim 11, wherein the instructions, when executed by the one or more processors, cause the one or more processors to update a node preference based on a majority choice selection in the blockchain network.

18. The system of claim 11, wherein the instructions, when executed by the one or more processors, cause the one or more processors to:
randomly sample a subset of the nodes; and
select the preference based on responses from the subset reaching the first threshold value.

19. The system of claim 11, wherein the instructions, when executed by the one or more processors, cause the one or more processors to:
randomly sample a subset of the nodes; and
detect that the blockchain network has decided based on at least the subset indicating a selected preference reaching a second threshold value.

20. A non-transitory computer-readable storage medium comprising instructions stored thereon, which when executed by one or more processors, cause the one or more processors to perform operations, comprising:
executing a first mechanism configured to determine a preference, from one or more choices, for nodes in a blockchain network based on a first threshold value of the nodes agreeing on a selection of one of the choices; and
executing a second mechanism configured to:
detect the blockchain network has decided on the selection based on a probabilistic analysis of node preferences; and
finalize a consensus decision of the blockchain network based on the node preferences.
